(19) United States
(12) Patent Application Publication
(10) Pub. No.: US 2012/0267289 A1
(43) Pub. Date: Oct. 25, 2012

(54) Reactor for Versatile Effluent Treatment System

(76) Inventor: Devron Kobluk, Brandon (CA)

(21) Appl. No.: 13/272,107

(22) Filed: Oct. 12, 2011

Related U.S. Application Data
(60) Provisional application No. 61/392,415, filed on Oct. 12, 2010.

(51) Int. Cl. C02F 1/68; C02F 1/00

(52) U.S. Cl. 210/85

(57) ABSTRACT

The present invention is reactor for treating water that includes a mixing tube having a length of L₁ arranged to receive wastewater and series of treatment chemical injectors located at distances D₁, D₂ and D₃ along length L₁ that inject a volume V of treatment chemicals into wastewater flowing through the mixing tube. Shaft with agitation members rotates at the rate of R to mix wastewater and injected treatment chemicals with periods of no mixing T for optimal conditions for treatment chemicals. T, R, D₁, D₂, D₃ and V are systematically varied by software in response to feedback from sensors within the reactor that monitor effluent concentrations and constituents within the wastewater.

### RELATED APPLICATIONS

This application claims priority to U.S. Provisional Application No. 61/392,415, filed Oct. 12, 2010.

### FIELD OF INVENTION

The present invention relates to the field of effluent treatment and more to a versatile effluent system and reactor.

### BRIEF DESCRIPTION OF THE DRAWINGS

FIG. 1 is an exemplary embodiment of a reactor for treating wastewater.

FIG. 2 is an exemplary embodiment of a reactor for treating wastewater in which mixing members are grouped to correspond with injection members.

FIG. 3 is an exemplary embodiment of a reactor for treating waste water in which each group of mixing members is independently controlled.

### GLOSSARY

As used herein, the term “effluent” means a compound comprised of water and other material. Effluent may include wastewater.

As used herein, the term “injection member” refers to any structure known in the art adapted to release a measurable volume of substance into a liquid, for example a treatment substance.

As used herein, the term “agitation member” means any structure known in the art used to agitate liquid. Examples of agitation members may include, but are not limited to, paddles, fins, beaters, blades or combinations thereof.

As used herein, the term “mixing tube” refers to any tubular structure adapted to contain flowing wastewater.

As used herein, the term “treatment chemical” refers to any chemical known in the art used to treat wastewater.

### BACKGROUND

Odor and potential pollution originating from livestock facilities are important issues that farmers, environmentalists and the general public seek to address. Typically, the issues of odor and pollution center on the handling and treatment of manure. When not handled properly, wastewater contaminated with manure may reach water supplies, such as lakes and streams. The stench may be a nuisance, but the potential for disease from contaminated water is a significant health risk for both animals and humans.

In addition to diseases carried in contaminated wastewater, solid waste contains other substances that may be detrimental to the environment, such as nitrogen, potassium and phosphorous. The release of these substances into the environment may be monitored by environmental organizations or limitedly controlled by government regulation.

In order to reduce the odor and potential pollution from livestock manure treatment, it is known to add various chemicals to wastewater in settling tanks which temporarily store wastewater. The chemicals act to flocculate the contaminants so that they can settle for collection at the bottom of the settling tank, leaving clarified water to be removed from the top of the settling tank. Conventionally, this takes several hours of settling, requiring very large tanks in order to accommodate a significant flow of wastewater.

One arrangement intended to allow settling of the materials within a few minutes, thus reducing the size of the equipment necessary, is shown in U.S. Pat. No. 4,710,290 to Briltz. Briltz teaches a tubular reactor through which wastewater flows A plurality of chemical injectors positioned along the length of the reactor inject treatment chemicals into the wastewater. Mixing devices within the reactor rotate to mix the wastewater and treatment chemicals. It will be appreciated that the mixing is highly important since it is necessary for the chemicals to mix intimately with the contaminants within the water so that flocculation occurs quickly.

A small settling tank is located downstream of the mixing chamber, allowing a dwell time of only a few minutes under the assumption that adequate flocculation has occurred within the reactor.

U.S. Pat. No. 6,932,905 to Briltz et al discloses an improved water treatment apparatus that includes a reactor with a plurality of injection members at spaced positions along the duct, each including a pump and a chemical supply for injecting a selected quantity of a selected chemical into the duct and each including a respective mixing member and rive for mixing the chemical into the water. An electrical separation section with a plurality of low voltage amorphous metal plates is also provided in the system and includes a duct into which the water is introduced.

One disadvantage with the systems described above is that the reactors must be manufactured to static specifications. In order to change the rate of mixing or amount of treatment chemical being added, the reactors must be manually adjusted to the newly calculated specifications.

Similarly, because the above systems must be manually adjusted, the systems will not respond to changes in wastewater qualities, such as effluent constituents and concentrations. The amount of phosphorous, nitrogen, potassium and other effluents in wastewater changes with variations in the formula of livestock feed. It is desirable to have a variable reactor structure that monitors the effluent qualities of wastewater and provides feedback to adjust effluent treatment system reactors.

It is desirable to have a variable reactor structure that can be adjusted and monitored with software capable of automatically adjusting the rate of mixing and amount of treatment chemicals being added.

It is desirable to have a variable reactor structure adapted with software that monitors effluent concentrations and constituents and automatically adjusts the mixing rate and amount and type of treatment chemical injected into the wastewater to provide real time optimum treatment of wastewater.

It is desirable to have a variable reactor structure which may be structurally adapted to remove a variety of effluent constituents at varying concentration levels.

It is desirable to have a variable reactor structure adapted to reduce emissions of methane and nitrous oxides.

### SUMMARY OF THE INVENTION

The present invention is an apparatus for treating water that includes a mixing tube having a length of L₁ arranged to receive wastewater and series of treatment chemical injectors located at distances D₁, D₂ and D₃ along length L₁ that inject a volume V of treatment chemicals into wastewater flowing through the mixing tube.

In the embodiments shown, chemical injectors may be commercially able pumps, spraying devices or other mechanical means for releasing liquid and powdered chemicals. In various embodiments, chemical injectors may be regulated or controlled by software.

Mixing tube also has a shaft having the length of L₂ that contains mixing members. Shaft with agitation members rotates at the rate of R to mix wastewater and injected treatment chemicals. Periods of no mixing for a time of T may be provided for optimal conditions for treatment chemicals. The variables of T, R, D₁, D₂, D₃ and V are systematically varied by software in response to feedback from sensors within the reactor that monitor effluent concentrations and constituents within the wastewater.

### DETAILED DESCRIPTION OF INVENTION

For the purpose of promoting an understanding of the present invention, references are made in the text to exemplary embodiments of a reactor for a versatile effluent treatment system, only some of which are described herein. It should be understood that no limitations on the scope of the invention are intended by describing these exemplary embodiments. One of ordinary skill in the art will readily appreciate that alternate but functionally equivalent structures and components may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

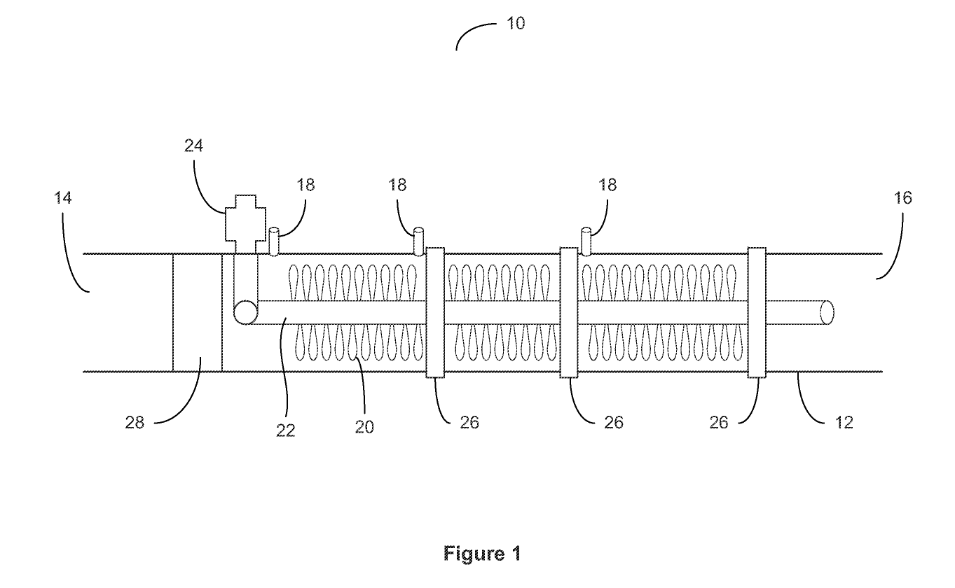

FIG. 1 is an exemplary reactor for treating wastewater 10. In the exemplary embodiment shown, mixing tube 12 is a tubular duct having a length of L₁ and arranged to receive contaminated wastewater flowing from inlet 14 to outlet 16. Wastewater may contain contaminants including, but are not limited to, solid waste, manure, hair, food particles, ammonia, phosphorous, nitrogen, potassium, heavy metals, odor causing compounds, pathogens and combinations thereof. L₁ may be varied to accommodate the volume and speed required for effluent processing in a particular system, and the number of mixing tubes within a system may also be varied.

In the exemplary embodiment shown, three injection members 18 are positioned at distances D₁, D₂ and D₃ along the length L₁ of mixing tube 12 for injecting treatment chemicals into the waste water.

Each injection member 18 includes a chemical supply (not shown) and pump (not shown) which injects a selected quantity of treatment chemical into the waste water. Injection members 18 may include more than one chemical supply, and one or more treatment chemicals may be injected from single injection member 18 at the same time. Injection members 18 may also include auxiliary agitation members (not shown) adapted to mix treatment chemicals before injection into the wastewater.

In further embodiments, distances D₁, D₂ and D₃ may vary depending on the treatment chemicals used and the concentrations and constituents of effluent in wastewater, and for various requirements in processing speed. In still further embodiments, distances D_{I}, D₂ and D₃ and the rate of discharge may be automatically varied by software in response to feedback from monitors located within mixing tube 12 that monitor the concentration and constituents of effluent within wastewater.

In the exemplary embodiment shown in FIG. 1, injection members 18 are adapted to inject a volume V or formulations of soda ash, polymer CIBA 1011 and aluminum sulfate. Soda ash and aluminum sulfate (and ferric; chloride, ferrous sulfate, and poly aluminum chloride) cause certain compounds to precipitate out of solution for easy removal and polymer CIBA 1011 is a coagulant aid. In further embodiments, injection members 18 may be adapted to inject commercially available wastewater treatment chemicals, such as Floccin enhancement and PGα21Ca. In still further embodiments, chemical formulations containing other naturally occurring or synthetic precipitation agents, coagulation aids, flocculants or odor control compounds may be used.

In still further embodiments, injection members 18 may be adapted to inject chemicals that remove pathogens and odor causing components from wastewater. In still further embodiments, injection members 18 may be adapted to inject chemicals that remove ammonia or heavy metals (such as copper and zinc) from wastewater.

The volume V of treatment chemical injected by each injection member 18 may vary depending on the concentration and constituents of effluents in wastewater flowing through mixing tube 12, and each injection member 18 may inject a different volume V of treatment chemical to optimize wastewater treatment.

The volume V, type and mixture of treatment chemical injected by injection members 18 may be automatically controlled by software adapted to respond to changes in effluent concentration and constituents feedback provided by monitors located within mixing tube 12.

A plurality of agitation members 20 are supported on shaft 22 extending axially along the length of mixing tube 12. In the embodiment shown, agitation members 20 are shown as paddles mounted generally radially along shaft 22 having a length of L₂. Shaft 22 is adapted to rotate, causing agitation members 20 to rotate with shaft 22 and mix the waste water. In further embodiments, other suitable generally radially projecting members mounted for rotation with the shaft to mix the waste water and the chemicals may be used.

In the embodiment shown in FIG. 1, shaft 22 has a length L₂ that is equivalent to the length L₁ of mixing tube 12. In further embodiments, shaft 22 may be divided into two or more portions of equal length L₂. In still further exemplary embodiments, shaft 22 may be divided into two or more portions of unequal length, with the sum of the lengths of each section (Lₓ) equal to the length L₁ of mixing tube 12. In still further embodiments, each portion of shaft 22 may be independently rotatable.

In the embodiment shown in FIG. 1, agitation members 20 are provided continuously along the length L₂ of shaft 22, spanning evenly along the length L₁ of mixing tube 12 between injection members 18.

Shaft 22 with agitation members 20 is driven by variable speed mixing motor 24, joined to shaft 22 by drive shaft (not shown). Any suitable right angle joint known in the art for connecting drive shaft of variable speed mixing motor 24 to shaft 22, such as a gear box or universal joint, may be used.

Shaft 22 is supported along mixing tube 12 by anchors 26 positioned along the length L₁ of mixing tube 12. Anchors 26 stabilize shaft 22 by projecting radially between shaft 22 and mixing tube walls. Anchors 26 include bearings for rotatably supporting shaft 22. Bearings may be any bearings known in the art to rotatably support shaft 22, such as ball bearings or roller bearings.

Catalyst injector 28 is located prior to injection members 18 near inlet 14 of mixing tube 12. Catalyst injector 28 injects a suitable catalyst into the waste water prior to the injection of any treatment chemicals. In the exemplary embodiment shown in FIG. 1, catalyst injector 28 injects a volume of yucca extract, Yucca extract supports bacteria necessary to breakdown natural wastes and binds ammonia and hydrogen sulfide gasses. Still further embodiments may use any chemical compound, naturally occurring or synthetic, known to aid in the breakdown of natural wastes or bind unwanted effluent compounds.

The amount of catalyst injected by catalyst injector 28 may vary depending on the concentration and constituents of effluent flowing through mixing tube 12. The amount of catalyst injected may be automatically controlled by software adapted to respond to feedback from Monitors located within mixing tube 12 that monitor the qualities of the wastewater.

The resulting solid product that is removed from the wastewater is an odorless powdered substance suitable for use as compost or fertilizer. The resulting product may also be sold as a secondary income for livestock farmers.

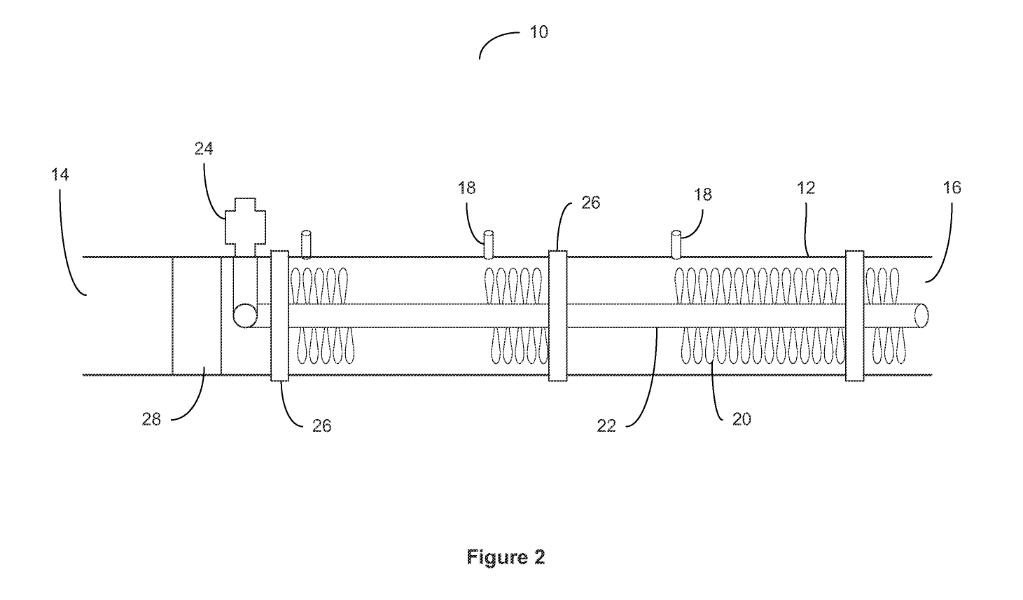

FIG. 2 is an exemplary reactor for treating wastewater 10 with periods of no mixing represented as T. Anchors 26 are variably spaced at distances A₁, A₂ and A₃ along the length L₂ of shaft 22 to accommodate a new arrangement of agitation members 20. Agitation members 20 are arranged along mixing tube 12 in separate groups with lengths of G₁, G₂ and G₃ and which correspond with a single injection member 18. Agitation members 20 within each group are arranged close to one another in an axial direction, with each group being spaced from one another by a much greater distance in the axial direction of mixing tube 12 than the space between any two agitation members 20 within a group.

In the exemplary embodiment shown in FIG. 2, the space between adjacent groups of agitation members 20 (S₁ and S₂) is greater than the length of the groups of agitation members 20 adjacent to the inlet (G₁). For example, the space between the middle group of agitation members 20 and the last group of agitation members 20 (S₂) is greater than the length of the first group of mixing members G₁ so as to thoroughly mix an unreacted treatment chemicals in the wastewater with contaminants prier to reaching outlet 16.

In the exemplary embodiment shown in FIG. 2, agitation members 20 are shown in three groups. In still further embodiments, agitation members 20 may be in more or less groups and correspond to one or more injection members 18. In still further embodiments, the space between groups of agitation members 20 may vary to accommodate more or fewer injection members 18.

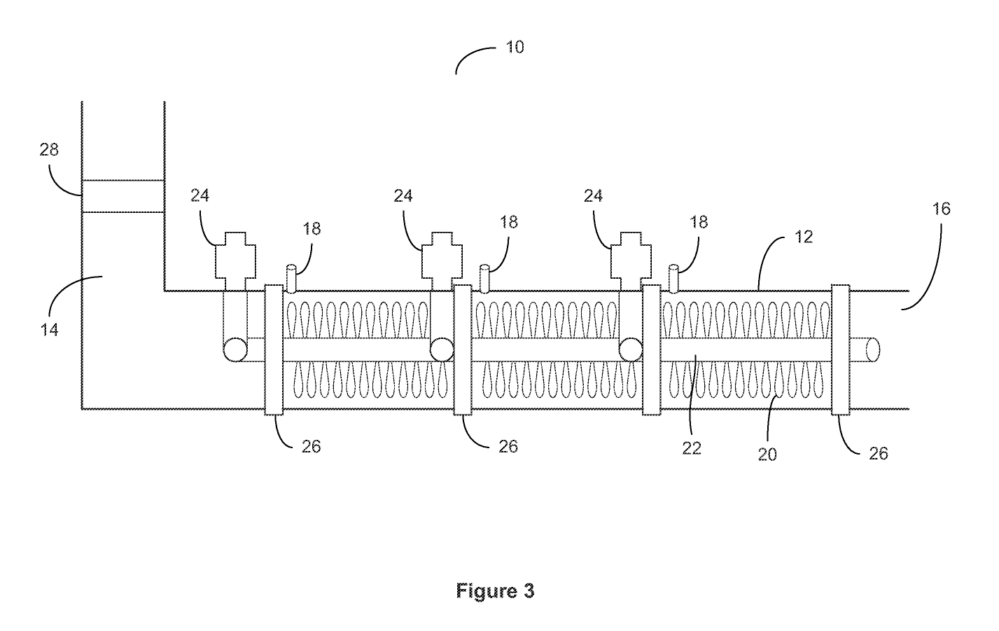

FIG. 3 is a further exemplary embodiment of a reactor for treating wastewater 10. In the exemplary embodiment shown, anchors 26 are placed at distances A₁, A₂ and A₃ along the length L₂ of shaft 22 in order to support shaft 22 at locations corresponding to variable speed mixing motors 24. In the exemplary embodiment shown in FIG. 3, shaft 22 is provided in three independently rotatable pieces with lengths of L₂, each powered by its own variable speed mixing motor 24. In the exemplary embodiment shown in FIG. 3, each portion of independently rotatable shaft 22 corresponds to injection members 18.

Each portion of shaft 22 contains a group of agitation members 20. In the exemplary embodiment shown, agitation members 20 cover the length L₂ of each independently rotatable section of shaft 22. In still further embodiments, periods of no mixing, such as illustrated in FIG. 3, may be provided, with mixing members occurring in groups with lengths of G₁, G₂ and G₃

In the exemplary embodiment shown in FIG. 3, variable speed mixing motors 24 may be independently controlled to vary the mixing rate R of each portion of independently rotatable shaft 22. Variable speed mixing motors may be automatically controlled by software adapted to respond to feedback from monitors within mixing tube 12 that monitor the concentration and constituents of effluent within the wastewater. Variable speed mixing motors 24 may be further adapted to be automatically controlled by software in response to changes in treatment chemical injections.

In the exemplary embodiments shown in FIGS. 1-3, the distance between injection members 18 (D₁, D₂ and D₃), volume of treatment chemicals injected (V), shaft length (L₂), periods of no mixing (T), mixing rate (R), distance between anchors (A₁, A₂ and A₃), agitation member 20 group lengths (G₁, G₂ and G₃) and the space between mixing groups (S₁ and S₂) may be automatically controlled and varied by software that is adapted to continuously respond to feedback from monitors within mixing tube 12. Monitors within mixing tube 12 continuously monitor the amount of wastewater entering and leaving mixing tube 12, the constituents of effluents in the wastewater, and the concentrations of effluents in the wastewater. Monitors may be strategically located at various positions inside mixing tube 12. For example, a monitor at net 14 may be able to monitor effluent changes in incoming wastewater to allow instantaneous adjustment of reactor components such as the type and volume of treatment chemical injected (V). A monitor located downstream from injection member 18 may be able to monitor treatment chemical activity and adjust the mixing rate (R) or periods of no mixing (T) accordingly.

The distance between injection members 18 (D₁, D₂ and D₃), volume of treatment chemicals injected (V), shaft length (L₂), periods of no mixing (T), mixing rate (R), distance between anchors (A₁, D₂ and A₃), agitation member 20 group lengths (G₁, G₂ and G₃) and the space between mixing groups (S₁ and S₂) may also be varied to provide optimal conditions for different treatment chemicals used. The types of treatment chemicals used may depend on the amount of wastewater entering mixing tube 12, the concentration of effluents and the constituents of effluents in the wastewater, but may also change to meet the personal preference of a user. For example, commercially available flocculants are available, and each product may require different conditions for optimal wastewater treatment. By providing a single reactor with variable parameters, reactor is easily adapted to be used with a range of wastewater treatment products.

While the effluent treatment system reactor 10 illustrated by the exemplary embodiments in FIGS. 1-3 is described for use with livestock, reactor 10 may also be adapted for use in sanitation systems processing human

The effluent treatment system described removes phosphorous from effluent which includes the following chemical origins: Orthophosphate, PO₄⁻³ Polyphosphates P₂O₇⁴ (Biological excrement), P₃O₁₀⁻⁵ (cleaning and detergent uses) and Organic Phosphates, ATE-ADP.

Wastewater may contain contaminants including, but not limited to, solid waste, manure, hair, food particles, organic particles, petroleum products, pharmaceuticals, volatile fatty acids, ammonia, phosphorus, nitrogen, potassium, heavy metals, odor causing compounds, pathogens and combinations thereof.

What is claimed is:

1. An reactor for treating waste water comprised of:
at least one mixing tube with a length of L₁ with an inlet and an outlet arranged for directing waste water from said inlet through said outlet;
at east three injection members positioned at distances D₁, D₂ and D₃ along said length L₁, each of said injection members adapted to inject a volume V of at least one treatment chemical into said waste water;
a plurality of agitation members supported within said mixing tube by a shaft having a length of L₂ and adapted to mix said at least one treatment chemical with said waste water within said mixing tube;
at least one mixing motor adapted to power said shaft to rotate said plurality of agitation members at a rate of R; and
a software component adapted to control said distances D₁, D₂ and D₃, said volume V, and said rate R and monitor concentrations and constituents of
at least one effluent in said wastewater.

2. The reactor of claim 1 wherein said plurality of agitation members is arranged in at least two groups with a length of G₁ and G₂ and separated by a distance of S₁.

3. The reactor of claim 2 wherein said software component is further adapted to control said distance S₁.

4. The reactor of claim 1 wherein said shaft is divided into at least two segments having lengths of Lₓ, wherein the sum of each Lₓ equals L₂.

5. The reactor of claim 1 wherein said shaft is divided into at least two independently rotatable segments.

6. The reactor of claim 5 wherein each of said at least two independently rotatable segments is further configured with a mixing motor.

7. The reactor of claim 1 wherein said at least one treatment chemical is selected from a group consisting of yucca extract, soda ash, polymer CIBA 1011, aluminum sulfate, Floccin enhancement, P.G. Alpha 21 Ca and combinations thereof.

8. The reactor of claim 1 wherein said effluent is selected from a group consisting of solid waste, manure, hair, food particles, ammonia, phosphorous, nitrogen, potassium, heavy metals, odor causing compounds, pathogens and combinations thereof.

9. The apparatus of claim 1 which further includes at least one software control module.
